(19) United States
(12) Patent Application Publication
(10) Pub. No.: US 2015/0059303 A1
(43) Pub. Date: Mar. 5, 2015

(54) Filter Element and Filter System

(71) Applicant: MANN+HUMMEL GMBH, Ludwigsburg (DE)

(72) Inventors: Dominic Koenig, Mannheim (DE); Marco Schilling, Roemerberg (DE); David Sachs, Speyer (DE)

(21) Appl. No.: 14/475,233

(22) Filed: Sep. 2, 2014

(30) Foreign Application Priority Data
Sep. 2, 2013 (DE) 10 2013 014 497.3

(51) Int. Cl. B01D 46/52

(52) U.S. Cl. CPC B01D 46/528
USPC 55/486

(57) ABSTRACT

The invention relates to a filter element (10) having a filter body (20 and a substantially axially sealing element (100) which is disposed at a peripheral surface (22) of the filter body (20), in particular foamed to the peripheral surface (22), wherein the sealing element (100) features a first sealing surface (102) and a second sealing surface (104) which are oppositely positioned to each other in axial direction with an axial gap (30). wherein the sealing element (100) features between the sealing surfaces (102, 104) at its circumference a contour (110) at which a contour segment (112, 114) each joins the sealing surface (102, 104) in an obtuse angle and the two contour segments (112, 114) abut at a joint (116).

The invention relates furthermore to a filter system (200) with a replaceable filter element (10).

### TECHNICAL FIELD

The invention relates to a filter element with a sealing element and a filter system with such a filter element.

### BACKGROUND

A filter element is known from U.S. 2008250766A which has a sealing element arranged on its outer side. The sealing element consists of polyurethane that is poured on the outer side and cured there on site.

It is one object of the invention to provide a filter element with a sealing element that has favorable demolding characteristics.

Another object of the invention is to provide a filter system with such a filter element.

The abovementioned objects are achieved according to one aspect of the invention through a filter element with a filter body and a substantially axially sealing element that is arranged on a peripheral surface of the filter body, particularly foamed to the peripheral surface, the sealing element having a first sealing surface and a second sealing surface that are positioned opposite each other in the axial direction with an axial gap, and the sealing element having a contour between the sealing surfaces on its periphery in which a contour segment respectively adjoins the sealing surface at an obtuse angle and the two contour segments abut at a joint.

Advantageous embodiments and advantages of the invention follow from the other claims, the description and the drawing.

### SUMMARY OF THE INVENTION

A filter element is proposed which has a filter body and a substantially axially sealing element that is arranged on a peripheral surface of the filter body, particularly foamed to the peripheral surface, the sealing element having a first sealing surface and a second sealing surface that are positioned opposite each other in the axial direction with an axial gap, and the sealing element having a contour between the sealing surfaces on its periphery in which a contour segment respectively adjoins the sealing surface at an obtuse angle and the two contour segments abut at a joint.

The person skilled in the art can expediently select an appropriate angle for a given housing in order to design the sealing surfaces such that they are sufficiently large and to adapt to the desired configuration of the filter system.

The sealing element is advantageously made of polyurethane. With its angular contour, the sealing element can easily be demolded from a casting mold that is used when applying the sealing element to the filter body. At the joint, which forms a kink running around the outer periphery of the sealing element, for example, a suitable seal in the casting mold can prevent flash from forming at the joint during foaming that would otherwise have to be tediously cut away by hand. Such flash can easily form, for example, at the edge of the sealing surface during the foaming of polyurethane if a right angle is formed between sealing surface and contour. By preventing such flash, the cycle time during the manufacture of the filter element can be shortened and damage during reworking of the filter element prevented, since this reworking can be omitted.

According to one advantageous embodiment, the joint can be arranged off-center with respect to the axial gap between the sealing surfaces. This can further simplify the manufacture and demolding of the sealing element compared to a joint that is arranged symmetrically with respect to the sealing surfaces. The mold, which prescribes the shape and size of the sealing element, is usually filled up to a level above the middle, and the polyurethane mass already begins foaming during filling of the casting mold.

According to one advantageous embodiment, one sealing surface can be shorter in the radial direction than the other sealing surface. Advantageously, a desired asymmetrical arrangement of the joint can be achieved more easily in this way and an angle between sealing surface and contour segment appropriately selected.

According to one advantageous embodiment, the joint can be further removed in the axial direction from the sealing surface that is shorter in the radial direction than from the sealing surface that is longer in the radial direction. The sealing element can thus be removed more easily from the casting mold. Particularly, the joint can be removed from the sealing surface that is shorter in the radial direction by at least 50% of the axial gap from the other sealing surface.

According to one advantageous embodiment, the obtuse angle can be between 100° and 140°, preferably between 110° and 112°. This rsults in a favorable inner contour of the casting mold.

According to one advantageous embodiment, at least the sealing surface that is longer in the radial direction can abut against the peripheral surface in a substantially spur-free manner. This saves material and reworking of the sealing element. This can be achieved in a simple manner by means of a suitable insert in the casting mold, for example.

According to one advantageous embodiment, a spout can extend from the sealing surface that is shorter in the radial direction and abut against the peripheral surface. This spout is advantageously short.

According to one advantageous embodiment, the filter element can be flowed through along its longitudinal axis. For this purpose, it is preferably formed of a wound semi-finished product made of a smooth layer and a corrugated layer lying on that of a filter medium such as paper, the channels formed between smooth and corrugated later being mutually sealed by tracks of hot melt adhesive, for example, so that the air to be filtered that flows into a channel must travel from this channel that is sealed at its end through a layer of the filter medium into an adjacent channel than is closed at its beginning, thus filtering the air. The wound body formed in this way forms two parallel, opposing inflow and outflow surfaces. Preferably, the sealing surfaces lie radially outside of the inflow and outflow surface and/or parallel thereto. In the case of a seal that is foamed to the filter body, the seal can be foamed directly to the outermost layer of a smooth layer. One of the sealing surfaces is also preferably flush with one of the inflow surfaces.

According to another aspect of the invention, a filter system with a housing and a filter element according to the invention is proposed, the filter element being arranged replaceably in the housing. By virtue of the replaceable filter element, the filter system is a good value.

The use of such a filter system as an air filter is especially advantageous. An economically priced air filter can be produced.

### BRIEF DESCRIPTION OF THE DRAWINGS

Additional advantages follow from the following description of the drawing. The drawings show exemplary embodiments of the invention. The drawings, the description and the claims contain numerous features in combination. The person skilled in the art will expediently also view the features individually and group them together into expedient additional combinations.

FIG. 1 shows, as a cutaway of a filter system, a section through a filter element with a filter body and a sealing element according to one embodiment of the invention foamed to it;

FIG. 2 shows, in a sectional view, detail of a foamed-on sealing element according to one embodiment of the invention;

FIG. 3 shows detail of a casting mold with sealing element

### DETAILED DESCRIPTION

In the figures, same or similar components are designated with the same reference symbols. The figures merely show examples and must not be understood as being limitative.

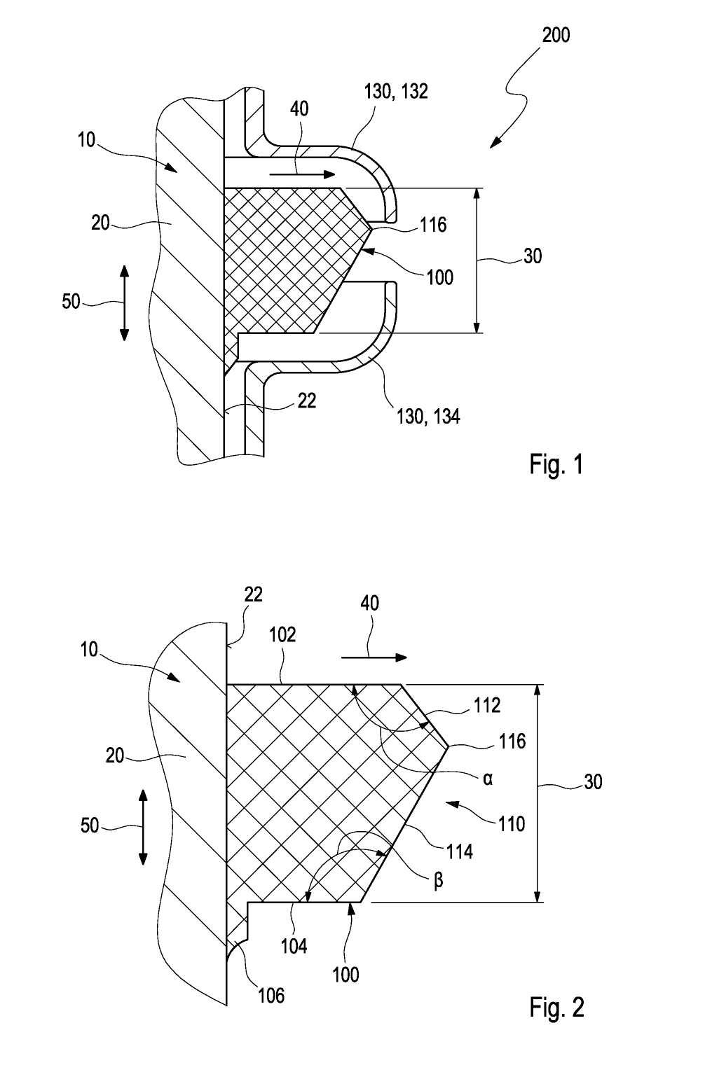

FIG. 1 shows, in a sectional view, a cutaway of a filter system 200 with a two-part housing 130 and a filter element 10 arranged therein with a sealing element 100. FIG. 2 shows the sealing element 100 in detail. The filter element 10 is, for example, an air filter with a filter body 20 which can be formed, for example, from paper as a filter medium. A sealing element 100 is arranged on the filter body 20 on its peripheral surface 22 in the radial direction 40.

The sealing element 100 is a substantially axially sealing element 100 made, for example, of polyurethane and foamed to the peripheral surface 22. The sealing element 100 has a first sealing surface 102 and, spaced apart from that in the axial direction 50, a second sealing surface 104 that are positioned opposite each other with an axial gap 30.

The filter element 10 is inserted into the housing 130, for example into a lower housing part with a radially projecting sealing surface 134. The upper housing part with a radially projecting sealing surface 132 is placed on top, so that the sealing element 100 is positioned with its sealing surfaces 102, 104 between the sealing surfaces 132, 134 of the housing 130. The housing 130 is closed and sealed through placement of a clamping ring (not shown) around the outwardly protruding sealing surfaces 132, 134 and tightened, thus pressing the pairs of sealing surfaces 132, 102 and 134, 104 against each other.

Between the two sealing surfaces 102, 104, the sealing element 100 has on its periphery a contour 110 in which a contour segment 112 adjoins the sealing surface 102 and in which the opposing sealing surface 104 adjoins the contour segment 114 at an obtuse angle α and β, respectively. The two angles α and β can be equal or different. It is advantageous if the obtuse angle α or β is in the range from greater than 90° to 150°, particularly from 100° to 140°, especially preferably in the range from 110° to 112°. When installing the filter element 10, it is difficult to position in the housing, particularly in the case of relatively large filter elements having a diameter of over 50 cm. The contour according to the invention reduces the danger of the sealing element 100 coming to rest with one of the sealing surfaces on one of the peripheral edges of the housing parts, thus damaging the sealing surface. The contour enables the oblique surfaces to slide on the housing contour and also provides a centering aid, so that a uniform sealing effect can be achieved all around.

One sealing surface 104 is shorter in the radial direction 40 than the other sealing surface 102.

The two contour segments 112, 114 protruding at an obtuse angle α or β from the sealing surfaces 102, 104 abut against each other at a joint 116. The joint 116 is arranged off-center with respect to the axial gap 30 between the sealing surfaces 102, 104 and is, for example, further removed in the axial direction 50 from the sealing surface 104 that is shorter in the radial direction 40 than from the sealing surface 102 that is longer in the radial direction 40, for example by at least 50% of the axial gap 30 from the other sealing surface 102.

The sealing surface 102 that is longer in the radial direction 40 abuts against the peripheral surface 22 in a substantially spout-free manner, whereas a spout 106 protrudes in the axial direction 50 from the sealing surface 104 that is shorter in the radial direction 40 and abuts against the peripheral surface 22. The spout 106 is formed during the casting or foaming-on of the sealing element 100 against the filter body 20.

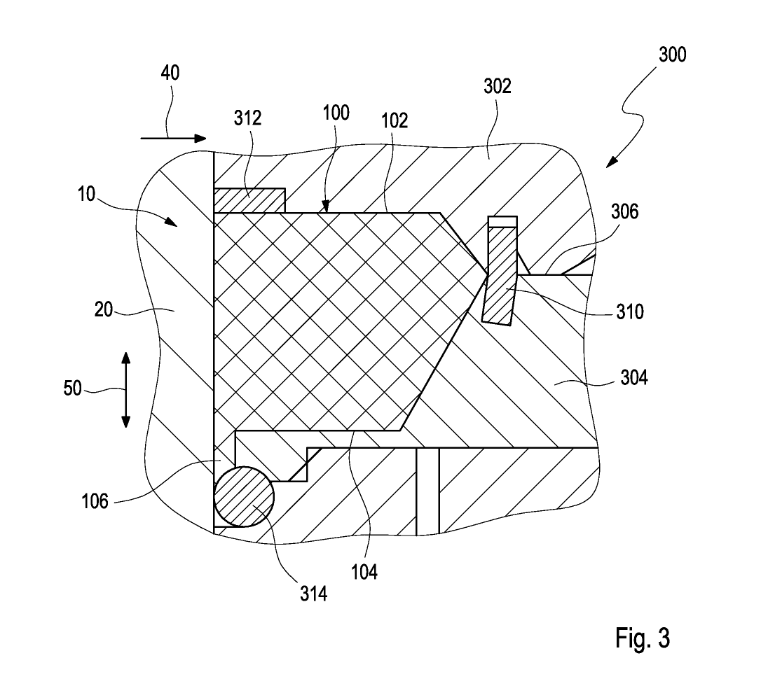

FIG. 3 shows detail of a casting mold 300 with sealing element 100 during the manufacture of the sealing element 100. The casting mold 300 has a lower shell 304 and an upper shell 302 that are placed tightly around the filter body 20. An insert 310 in the form of a seal is inserted at a joint 306 between the shells 302, 304. The lower shell 304 is sealed against the filter body 20 with an insert 314 in the form of an elastic O-ring. This insert 314 advantageously limits the flashing of the polyurethane during foaming that forms the spout 106 of the sealing element 100.

An annular insert 312 is inserted in the upper shell 302 at the transition to the filter body 20 that prevents the foaming polyurethane introduced into the casting mold from forming a spout and ensures that the corresponding sealing surface of the sealing element 100 abuts against the filter body 20 without flash, for example practically perpendicularly.

1. A filter element (10), particularly for filtering air, with a filter body (20) that can be axially flowed through, is wound from a semi-finished product made of a smooth layer and a corrugated layer of a filter medium, and has mutually closed channels having an inflow surface and an outflow surface running parallel thereto, and a substantially axially sealing element (100) that is foamed to a peripheral surface (22) of the filter body (20), wherein the sealing element (100) has a first sealing surface (102) and a second sealing surface (104) that are positioned opposite each other in the axial direction with an axial gap (30), and wherein the sealing element (100) has a contour (110) between the sealing surfaces (102, 104) on its periphery in which a contour segment (112, 114) respectively adjoins the sealing surface (102, 104) at an obtuse angle and the two contour segments (112, 114) abut at a joint (116).

2. The filter element as set forth in claim 1, wherein the joint (116) is arranged off-center with respect to the axial gap (30) between the sealing surfaces (102, 104).

3. The filter element as set forth in claim 1, wherein one sealing surface (104) is shorter in the radial direction (40) than the other sealing surface (102).

4. The filter element as set forth in claim 1, wherein the sealing surfaces (102, 104) run parallel to each other.

5. The filter element as set forth in claim 1, wherein the sealing surfaces (102, 104) run parallel to the inflow and outflow surface of the filter body.

6. The filter element as set forth in claim 1, wherein the joint (116) is further removed in the axial direction (50) from the sealing surface (104) that is shorter in the radial direction (40) than from the sealing surface (102) that is longer in the radial direction (40).

7. The filter element as set forth in claim 1, wherein the joint (116) is removed from the sealing surface (104) that is shorter in the radial direction (40) by at least 50% of the axial gap (30) from the other sealing surface (102).

8. The filter element as set forth in claim 1, wherein the obtuse angle is between 100° and 140°, preferably between 110° and 112°.

9. The filter element as set forth in claim 1, wherein at least the sealing surface (102) that is longer in the radial direction (40) abuts against the peripheral surface (22) in a substantially spout-free manner.

10. The filter element as set forth in claim 1, wherein a spout (106) protrudes in the axial direction (50) from the sealing surface (104) that is shorter in the radial direction (40) and abuts against the peripheral surface (22).

11. A filter system (200) with a housing and a filter element (10) as set forth in claim 1, wherein the filter element (10) is arranged replaceably in the housing.
